(19) United States
(12) Patent Application Publication
(10) Pub. No.: US 2022/0412251 A1
(43) Pub. Date: Dec. 29, 2022

(54) DUAL ZONE COOLING SYSTEM FOR COMBINED ENGINE COMPRESSORS

(71) Applicant: ONBOARD DYNAMICS LLC, Bend, OR (US)

(72) Inventors: Daniel S. PEDERSEN, Fort Collins, CO (US); Guy R. BABBITT, Fort Collins, CO (US); Kristina WEYER-GEIGEL, Yakima, WA (US)

(21) Appl. No.: 17/670,185

(22) Filed: Feb. 11, 2022

Related U.S. Application Data
(63) Continuation of application No. 16/625,512, filed on Dec. 20, 2019, now abandoned.
(60) Provisional application No. 62/537,722, filed on Jul. 27, 2017.

(51) Int. Cl. F02B 43/04; F01P 3/02; F02B 43/12; F02M 21/02; F02M 31/20

(52) U.S. Cl. CPC F02B 43/04; F01P 3/02; F02B 43/12; F02M 21/0245; F02M 31/20; F01P 2003/021; F02B 2043/103

(57) ABSTRACT

Typically, an engine-compressor for compressing natural gas for use as a fuel has a single cooling circuit to cool both its combustion unit and compression unit. A single cooling circuit design is not ideal because the optimal temperature for the combustion unit is higher than the compression unit of the engine-compressor. The present invention provides a dual zone cooling system to cool the combustion unit separately from the compression unit.

### STATEMENT REGARDING FEDERALLY SPONSORED RESEARCH OR DEVELOPMENT

This invention was made with government support under DE-AR0000490 awarded by the U.S. Department of Energy. The government has certain rights in the invention.

### BACKGROUND

Natural gas is an attractive fuel for vehicles due to its low cost and reduced emissions, including greenhouse gases. However, for effective use as a vehicle fuel, natural gas must be compressed to high pressure (typically 4000 psi).

An internal combustion engine may compress natural gas for vehicle fuel. This engine may contain a plurality of compression cylinders, at least one standard combustion cylinder to drive the plurality of compression cylinders, and a common crankshaft coupling the plurality of compression cylinders and the at least one standard combustion cylinder. The compression cylinders are in fluid communication with each other, and are configured to compress gas in a series of stages. Gas compression causes the gas to heat. Thus, gas travels through a heat exchanger after each stage of compression. U.S. Pat. No. 5,400,751, incorporated by reference herein, provides further details regarding natural gas compressors.

FIG. 1 shows a typical engine cooling circuit for an engine-compressor. Both the combustion unit 10, including at least one combustion cylinder 16 and combustion head 18, and compression unit 12, including a plurality of compression cylinders 20 and compression head 22, use the same coolant. Pump 14 circulates fluid (e.g., water or a water-antifreeze mixture) to both the combustion unit 10 and compression unit 12. Thermostat 24 checks the temperature of the fluid to determine whether the fluid needs to be cooled by engine radiator 26. A typical engine cooling circuit also includes a coolant overflow reservoir (not shown) and a way to control the pressure, e.g., a radiator cap (not shown).

Thus, the compression unit in an engine-compressor configuration is normally cooled with the same fluid as the combustion unit despite the combustion cylinders having a higher optimal operating temperature compared to the compression cylinders. Typical temperatures for coolant flowing into the compression and combustions systems may be from 150° F. to 250° F., from 175° F. to 225° F., from 190° F. to 210° F., from 190° F. to 200° F., or about 195° F.

The power cylinders (i.e., combustion cylinders) need to operate at a higher temperature to maintain high engine efficiency, e.g., less fuel consumption and lower emissions. However, too high of temperatures may cause structural damage, including damage to seals and valves. In contrast, the compression cylinders should be operated at a lower temperature than the combustion cylinders for thermodynamic reasons, i.e., at lower temperatures, the compression process behaves closer to isothermal rather than adiabatic, which inherently requires less energy. Lower temperatures in the compression stages also decrease the wear on valves and seals and reduce energy consumption.

The cooling system for the combustion cylinders within the combustion unit of a typical engine-compressor system may be sized to keep these cylinder walls operating at, for example, between 230° F. and 290° F. Cooling system size is determined by factors such as coolant type (water, water/antifreeze mixture, other, etc.), radiator size, design ambient temperature range, radiator size and material, air flow through the radiator, size and design of the coolant pump, operating RPM (and operating RPM range) of the coolant pump, material used in the combustion cylinders, type of lubricant used, and designed cooling load of lubricant.

In contrast, the compression cylinders within the compression unit do not practically have a lower temperature limit. However, the operating temperature for the compression cylinders is determined by the design of the cooling system including the constraints of the combustion cylinders as described above and cannot be lower than the low temperature heat sink (usually ambient air) used to cool these cylinders. Designers design a compressor cooling system by trading off the cost, weight, volume, or combination thereof for the system against the amount of cooling provided. Thus, the operating temperature for the compression cylinder walls of a typical engine-compressor system without the improved features suggested herein may be higher than optimal, such as 215° F. to 280° F.

### SUMMARY

The present invention provides for a way to cool the compression cylinders at a lower temperature compared to the combustion cylinders such that each system may operate with greater efficiency and durability.

A possible way to provide such an advantage includes an internal combustion engine for compressing gas, comprising: (a) a compression unit for compressing gas; (b) a combustion unit for driving the compression unit; (c) a first coolant circuit to cool the compression unit; and (d) a second coolant circuit to cool the combustion unit.

Another way to provide such an advantage is a method for cooling an internal combustion engine for compressing gas comprising: providing the internal combustion engine comprising (a) a compression unit for compressing gas; (b) a combustion unit for driving the compression unit; (c) a first coolant circuit to cool the compression unit; and (d) a second coolant circuit to cool the combustion unit; cooling the compression unit with the first cooling system; and cooling the combustion unit with the second cooling system, and wherein the temperature of the combustion unit is higher than the temperature of the compression unit.

An additional way to provide such an advantage is a method for cooling an internal combustion engine for compressing gas comprising: providing the internal combustion engine comprising (a) a bimodal unit comprising a plurality of bimodal cylinders for compressing and combusting gas; (b) a combustion unit comprising at least one combustion cylinder for driving the bimodal unit during compression mode; (c) a first coolant circuit; and (d) a second coolant circuit; compressing gas using the bimodal unit while cooling the bimodal unit with the first coolant circuit and cooling the combustion unit with the second coolant circuit, and wherein the temperature of the combustion unit is higher than the temperature of the bimodal unit when the bimodal unit is compressing gas.

### DESCRIPTION OF THE DRAWINGS

FIG. 1 is a schematic for a typical engine cooling circuit for an engine-compressor.

FIG. 2 is a schematic for a dual zone cooling system for an engine-compressor.

FIG. 3 is a schematic for a cooling system for a three stage gas compression unit.

### DETAILED DESCRIPTION

The present invention involves splitting the coolant flow passages of the engine-compressor between the compression unit and the combustion unit. The designer may independently optimize (including reducing the cost of) the cooling of the compressor and combustion cylinders by providing a separate cooling systems for each.

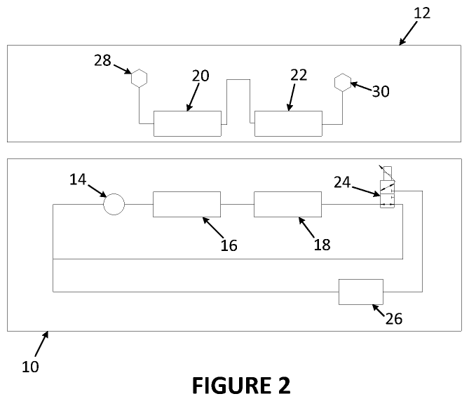

As shown in FIG. 2, the compression unit 12 has been separated from the combustion unit 10 such that compression unit 12 uses a coolant circuit with a cooling supply 28 and a cooling return 30, while the combustion unit 10 uses a coolant circuit including pump 14, thermostat 24 and engine radiator 26. In FIG. 2, the compression unit 12, including a plurality of compression cylinders 20, and compression head 22, are cooled to a lower temperature compared to the combustion unit 10, including at least one combustion cylinder 16 and combustion head 18. Preferably, both the combustion unit 10 and the compression unit 12 would operate at their optimal temperatures.

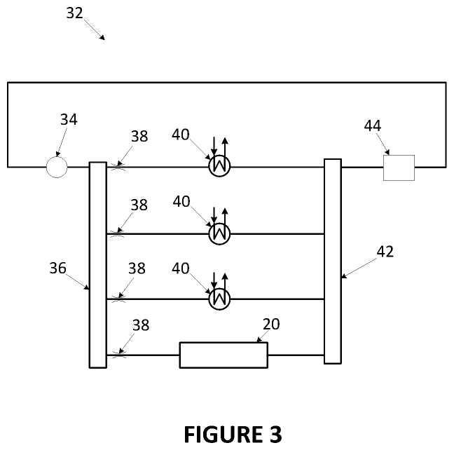

FIG. 3 is an example heat exchanger coolant system 32 for a three stage compression unit. As shown in FIG. 3, a pump 34 moves coolant through the supply coolant manifold 36 and fittings 38 to the plurality of compression cylinders 20 and a plurality of interstage heat exchangers 40. The fittings 38 balance the flow of coolant for optimal operating temperature. In place of one or more of the fittings 38, fittings with orifices, another kind of flow control device, or a combination thereof may be used. Coolant flow may also be controlled by line size in place of one or more of the fittings 38. Each stage has its own heat exchanger 40. The coolant would then circulate to the return coolant manifold 42 and through radiator 44 back to pump 34. While coolant flows simultaneously through the plurality of compression cylinders 20 and interstage heat exchangers 40 in FIG. 3, the flow of coolant through the compressor unit of the engine may be of any sequence. For example, flow through the various heat load sources may be parallel (as shown) or serial, of any combination while not flowing through the combustion portion of the engine.

The seals of the compression unit in a dual zone cooling system may be the same or different compared to the seals of the compression unit in a single zone cooling system. The valves of the compression unit in a dual zone cooling system may be the same or different compared to the valves of the compression unit in a single zone cooling system. If the same seals, valves, or both were used, they would last longer in the compression unit in a dual zone cooling system because the compression seals, valves or both of a dual zone cooling compression system may be operated at a lower temperature compared to a single zone cooling compression system.

The amount of energy used to compress gas in an engine-compressor with a dual zone cooling system may be less, e.g., 1% to 5% less, 2% to 5% less, 1% to 10% less, or 5% to 10% less, compared to the amount of energy used to compress gas in a typical engine-compressor with a single zone cooling system. Dual zone cooling can thus contribute simultaneously to two important operating characteristics of such compressors: lower energy consumption (and associated lower environmental impact and lower costs) and longer life of key, temperature-critical components (seals and valves).

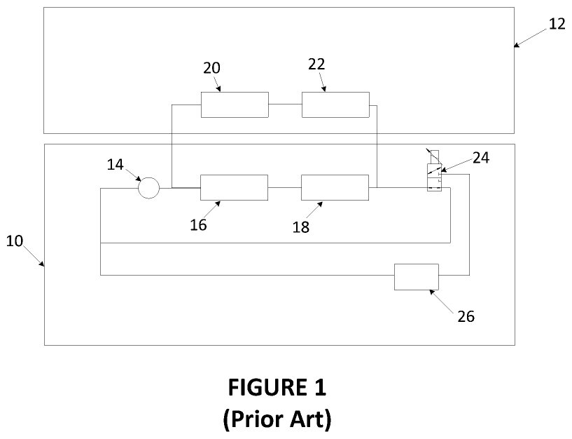

As discussed above and as shown in FIG. 1 and FIG. 2, the coolant for the cooling system of the combustion unit 10 may be circulated by pump 14 and cooled using radiator 26 while the temperature of the coolant may be controlled using thermostat 24 and/or a temperature-regulated fan (not shown) on the radiator. The coolant for compression unit 12 may be cooled, for example, using radiator 44 as shown in FIG. 3.

The cooling system for the combustion cylinders of a dual zone cooling system may be sized to keep these cylinders' walls operating at, for example, between 230° F. and 290° F., between 250° F. and 290° F., or between 270° F. and 290° F., which is similar to a single zone system. Again, similar to the single zone system, typical temperatures for coolant flowing into the combustion unit may be from 150° F. to 250° F., from 175° F. to 225° F., from 190° F. to 210° F., from 190° F. to 200° F., or about 195° F.

However, the cooling system for the compression cylinders of a dual zone cooling system may be sized to keep these cylinder walls operating at, for example, no more than 20° F., no more than 50° F., or no more than 80° F. above ambient temperature. Typical temperatures for coolant flowing into the compression unit may be from 190° F. to 220° F., from 170° F. to 240° F., from 150° F. to 250° F., from 50° F. to 100° F., or from 80° F. to 120° F. Further, typical temperatures for coolant flowing into the compression unit may be from ambient to 10° F. above ambient, 20° F. above ambient, 30° F. above ambient, 40° F. above ambient, 50° F. above ambient, 60° F. above ambient, 70° F. above ambient, or 80° F. above ambient.

The coolant for the cooling system for both combustion unit 10 and compression 12 may be of the same or different composition. The coolant composition may be water, a mix of water and antifreeze, oil, or a commercially available automotive coolant. The coolant may be designed to minimize corrosion in the system, operate under a wide range of ambient conditions and to provide good heat transfer characteristics with long life.

### Other Embodiments

While three stage cylinder gas compressors are exemplified, as few as two stages or more than three stages may be used. Generally, more stages mean that gas may be serially compressed to a higher pressure.

The plurality of compression cylinders as described above may be powered by the at least one standard combustion cylinder, but be external from the internal combustion engine. In other words, in a system for compressing gas, compression cylinders are separate from an internal combustion engine, but driven by the internal combustion engine. In a dual zone cooling system for this “crosshead” design, similar to the system described above, one coolant cools the compression unit while the other coolant cools the combustion unit. This “crosshead” design is described in U.S. Pat. No. 5,400,751, incorporated by reference herein.

The plurality of compression cylinders as described above may be bimodal by also running as combustion cylinders (i.e., compression cylinders in combustion mode) such that all the cylinders of the engine are providing power for, e.g., a vehicle. Such “on-board” dual-mode compression systems are described in U.S. Pat. No. 9,528,465, the entire disclosure of which is incorporated by reference herein. When the dual-mode compression system is working as a compressor, the dual zone cooling system as described herein may separately cool the bimodal unit working as a compression unit and the combustion unit. When the dual-mode compression system is working exclusively in combustion mode, (a) a single cooling circuit (e.g., the combustion unit cooling circuit) may cool the bimodal unit working in combustion mode and the combustion unit while the other cooling system is not working or (b) the dual zone cooling system as described herein may separately cool the bimodal unit working as a combustion unit and the combustion unit to a temperature appropriate for combustion as described above.

Typically, one cylinder compresses the gas, the gas moves into a dedicated heat exchanger for the cylinder, and the gas moves to the next cylinder for further compression. Alternatively, multiple cylinders may compress a gas to a single pressure and the gas then may move to another set of multiple compression cylinders for further compression or to the gas outlet. When a single stage of compression includes multiple cylinders, each compression cylinder may have a corresponding heat exchanger (i.e., one to one correspondence) or multiple cylinders from a single stage may share a heat exchanger.

While a dual zone cooling system is exemplified, more than two zones of cooling may be present in an engine-compressor. For example, the four compression cylinders may be split with two cylinders compressing one gas and two cylinders compressing a second gas such that each gas as well as the combustion cylinders have separate cooling systems. An architecture for compressing more than one type of gas is described in U.S. Provisional Application Ser. No. 62/482,618 and is incorporated by reference herein.

The present invention is not to be limited in scope by the specific embodiments described herein. Indeed, various modifications of the invention in addition to those described herein will be apparent to those skilled in the art from the foregoing description. Such modifications are intended to fall within the scope of the appended claims.

All references cited herein, including all patents, published patent applications, and published scientific articles and books, are incorporated by reference in their entireties for all purposes.

What is claimed is:

1. An internal combustion engine for compressing gas, comprising:
(a) a compression unit for compressing gas;
(b) a combustion unit for driving the compression unit;
(c) a first coolant circuit to cool the compression unit; and
(d) a second coolant circuit to cool the combustion unit.

2. The internal combustion engine of claim 1, wherein the combustion unit comprises at least one combustion cylinder and the compression unit comprises a plurality of compression cylinders.

3. The internal combustion engine of claim 2, wherein the compression unit comprises a plurality of heat exchangers to cool the gas from the plurality of compression cylinders.

4. The internal combustion engine of claim 3, wherein each compression cylinder has a corresponding heat exchanger of the plurality of heat exchangers.

5. The internal combustion engine of claim 2, further comprising a common crankshaft coupling the at least one combustion cylinder and the plurality of compression cylinders wherein the at least one combustion cylinder drives the plurality of compression cylinder.

6. The internal combustion engine of claim 2, wherein the plurality of compression cylinders is a plurality of bimodal cylinders capable of both compression and combustion.

7. The internal combustion engine of claim 6, wherein the second coolant circuit is configured to cool the plurality of bimodal cylinders.

8. A method for cooling an internal combustion engine for compressing gas comprising:
providing the internal combustion engine comprising (a) a compression unit for compressing gas; (b) a combustion unit for driving the compression unit; (c) a first coolant circuit to cool the compression unit; and (d) a second coolant circuit to cool the combustion unit;
cooling the compression unit with the first cooling system; and
cooling the combustion unit with the second cooling system, and
wherein the temperature of the combustion unit is higher than the temperature of the compression unit.

9. The method of claim 8, wherein the combustion unit comprises at least one combustion cylinder and the compression unit comprises a plurality of compression cylinders.

10. The method of claim 9, wherein the compression unit comprises a plurality of heat exchangers to cool the gas from the plurality of compression cylinders.

11. The method of claim 10, wherein each compression cylinder has a corresponding heat exchanger of the plurality of heat exchangers.

12. The method of claim 9, wherein the internal combustion engine further comprises a common crankshaft coupling the at least one combustion cylinder and the plurality of compression cylinders wherein the at least one combustion cylinder drives the plurality of compression cylinders.

13. The method of claim 9, wherein the temperature of the at least one combustion cylinder wall is between 230° F. and 290° F.

14. The method of claim 9, wherein the temperature of the plurality of compression cylinder walls is no more than 80° F. above ambient temperature.

15. A method for cooling an internal combustion engine for compressing gas comprising:
providing the internal combustion engine comprising (a) a bimodal unit comprising a plurality of bimodal cylinders for compressing and combusting gas; (b) a combustion unit comprising at least one combustion cylinder for driving the bimodal unit during compression mode; (c) a first coolant circuit; and (d) a second coolant circuit;
compressing gas using the bimodal unit while cooling the bimodal unit with the first coolant circuit and cooling the combustion unit with the second coolant circuit, and
wherein the temperature of the combustion unit is higher than the temperature of the bimodal unit when the bimodal unit is compressing gas.

16. The method of claim 15, further comprising combusting gas using the bimodal unit while cooling the bimodal unit with the first coolant circuit.

17. The method of claim 16, wherein the temperature of the plurality of bimodal cylinder walls is between 230° F. and 290° F. when the bimodal unit is combusting gas.

18. The method of claim 15, further comprising combusting gas using the bimodal unit while cooling the bimodal unit with the second coolant circuit.
